(19) United States
(12) Patent Application Publication
(10) Pub. No.: US 2016/0203177 A1
(43) Pub. Date: Jul. 14, 2016

(54) Answering Requests Related to Places of Interest

(71) Applicant: Google, Inc., (US)

(72) Inventor: Gabriel Taubman, Brooklyn, NY (US)

(73) Assignee: Google, Inc., Mountain View, CA (US)

(21) Appl. No.: 13/741,477

(22) Filed: Jan. 15, 2013

Related U.S. Application Data
(60) Provisional application No. 61/654,450, filed on Jun. 1, 2012.
(60) Provisional application No. 61/654,518, filed on Jun. 1, 2012.

(51) Int. Cl. G06F 17/30

(52) U.S. Cl. CPC G06F 17/30386

(57) ABSTRACT

Methods, systems, and apparatus, including computer programs encoded on a computer storage medium, for performing providing responses to requests are disclosed. The methods, systems, and apparatus include actions of receiving, by a dialog system, a request that is entered by a user into a user device and determining, by the dialog system, that the request is classified as a place-triggering request. Further actions include, based on determining that the request is classified as a place-triggering request, identifying, by the dialog system, one or more words that occur in the request. The actions also include identifying, by the dialog system and using a data structure that associates words to categories of places of interest, one or more categories that are associated with the one or more words. Additionally, the actions include selecting, by the dialog system, one or more places of interest that match one or more of the categories.

### CROSS-REFERENCE TO RELATED APPLICATIONS

This application claims the benefit of U.S. Provisional Patent Application No. 61/654,450, filed Jun. 1, 2012, and U.S. Provisional Patent Application No. 61/654,518, filed Jun. 1, 2012, the entireties of which are hereby incorporated by reference as if fully set forth therein.

### TECHNICAL FIELD

This specification generally relates to providing responses to requests from users.

### BACKGROUND

User devices, such as mobile telephones, implement a variety of techniques through which users can find information. For example, some user devices implement dialog systems, which may be able to audibly provide answers to questions provided by users. In some instances, the answer to a question may be an identification of a place of interest, such as the name of a business, an address, or the like.

### SUMMARY

In general, an aspect of the subject matter described in this specification may involve a dialog system that provides responses identifying places of interest in response to requests from users. The dialog system may determine that a request is classified as a place-triggering request. Based on determining that the request is a classified as a place-triggering request, the one or more devices may identify one or more words that occurs in the request and identify one or more categories of places of interest that are associated with the one or more words. The one or more devices may select one or more places of interest that match one or more of the categories and may provide the user a response including information identifying the selected one or more places of interest.

By determining that some requests are classified as place-triggering requests, a system, according to one or more implementations described herein, may output responses that include information regarding one or more places of interest that are related to the requests. These responses may be particularly accurate for place-triggering requests, thus enhancing users' experiences.

In some aspects, the subject matter described in this specification may be embodied in methods that include the actions of receiving, by a dialog system, a request that is entered by a user into a user device and determining, by the dialog system, that the request is classified as a place-triggering request. Further actions include, based on determining that the request is classified as a place-triggering request, identifying, by the dialog system, one or more words that occur in the request. The actions also include identifying, by the dialog system and using a data structure that associates words to categories of places of interest, one or more categories that are associated with the one or more words. Additionally, the actions include selecting, by the dialog system, one or more places of interest that match one or more of the categories.

Other embodiments of these aspects include corresponding systems, apparatus, and computer programs, configured to perform the actions of the methods, encoded on computer storage devices.

These and other embodiments may each optionally include one or more of the following features. For instance, in some implementations the place-triggering request is a request including a term associated with place-triggering requests, or a request for which the dialog engine selects one or more places of interest. In some implementations, the dialog system determines that the request is classified as a place-triggering request by determining the request includes the term. Some implementations involve transmitting data identifying one or more of the selected places of interest to the user device.

In some implementations, the one or more words may be two or more words that occur successively in the request. In other implementations, the dialog system identifies the one or more categories by determining one or more categories of the categories of places of interest where the one or more words that occur in the request are at least one of, an exact match to or beyond a similarity threshold with, one or more words the data structure associates with the one or more categories.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF THE DRAWINGS

FIGS. 1A-1C illustrate an overview of example implementations described herein;

FIG. 2 illustrates an example environment in which systems and/or methods described herein may be implemented;

FIG. 3 illustrates an example of a generic computer device and a generic mobile computer device according to one or more implementations described herein;

FIGS. 4 and 5 illustrate example functional components of a place of interest dialog system according to one or more implementations described herein;

FIGS. 6 and 7 illustrate example data structures that may be stored by a place of interest dialog system according to one or more implementations described herein;

FIG. 8 illustrates a flowchart of an example process for generating or modifying category scores of n-grams extracted from documents that include information regarding places of interest, according to one or more implementations described herein;

FIG. 9 illustrates a flowchart of an example process for categorizing n-grams associated with places of interest, according to one or more implementations described herein; and

FIG. 10 illustrates a flowchart of an example process for responding to place-triggering requests, according to one or more implementations described herein.

In the drawings, like reference numbers represent corresponding parts throughout.

### DETAILED DESCRIPTION

A system and/or method, described herein, may enable one or more devices to provide responses to requests from users. A request may include a question, statement, or command. The one or more devices may determine that a request is classified as a place-triggering request. A place-triggering request may be a request for which the one or more devices selects one or more places of interest and provides a response identifying the one or more selected places of interest. For example, the response may identify a name of a business, a physical address, a name of a geographical region, or the like.

Based on determining that the request is a classified as a place-triggering request, the one or more devices may identify one or more words that occur in the request and identify one or more categories of places of interest that are associated with the one or more words. Categories of places of interest may include “Mexican restaurants,” “French restaurants,” “Food,” “Bars,” “Nightlife,” “Automotive,” and “Health and Medical.” The one or more devices may select one or more places of interest that match one or more of the categories and may provide the user a response including information regarding the selected one or more places of interest. A place of interest may match a category if the place of interest is identified, e.g., in a database of places and categories, as being associated with the category.

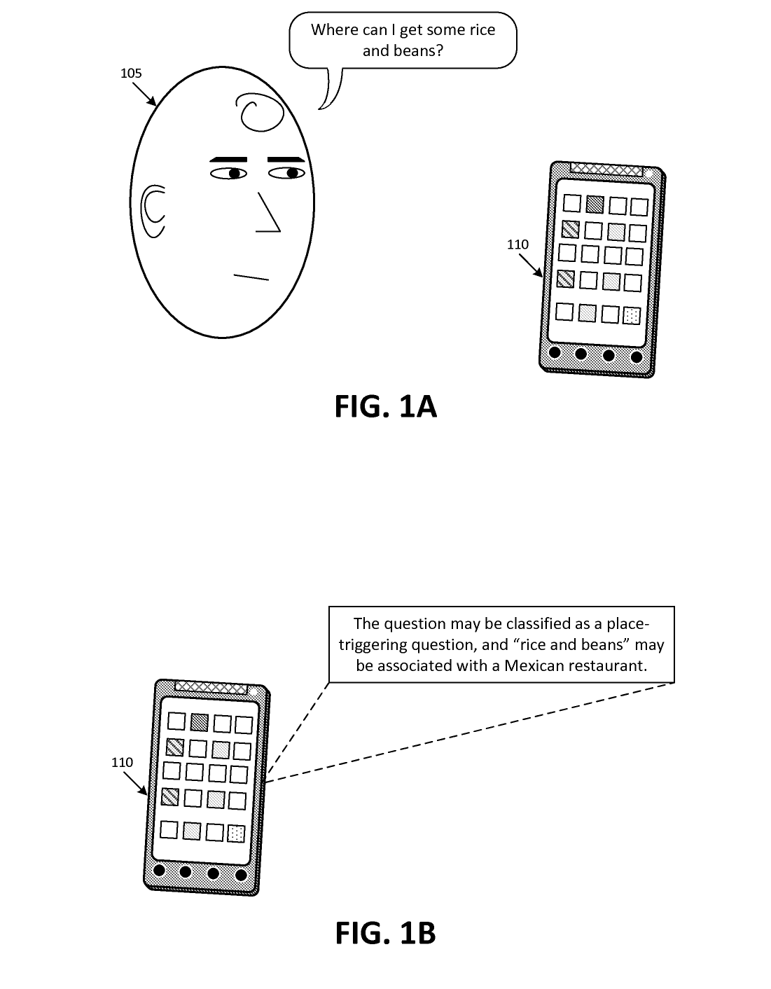

FIGS. 1A-1C illustrate an overview of example implementations described herein. As shown in FIG. 1A, user 105 may provide a request in the form of asking the question “Where can I get some rice and beans?” to user device 110. In this case, the question may be a place-triggering question. A place-triggering question may be a place-triggering request where the request is a question. Alternatively, user 105 may provide the statement “I am looking for some rice and beans” or the command “find me some rice and beans.” As shown in FIG. 1B, user device 110 may determine that the request is classified as a place-triggering request, and that the phrase “rice and beans” is associated with a category of place of interest where the category is “Mexican restaurant.” A phrase may include one word that occurs in the request, or two or more words that occur successively in the request.

User device 110 may provide a response to the request based on determining that the request is classified as a place-triggering request and that the phrase “rice and beans” is associated with a Mexican restaurant. For example, as shown in FIG. 1C, user device 110 may provide information regarding a search performed based on determining that the request is classified as a place-triggering request and that the phrase “rice and beans” may refer to a Mexican restaurant. The performed search may be a search for Mexican restaurants near user device 110. Accordingly, the information provided by user device 110 may include the phrase “The nearest Mexican restaurant, Uncle Julio's Rio Grande Café, is 1 kilometer away from you.”

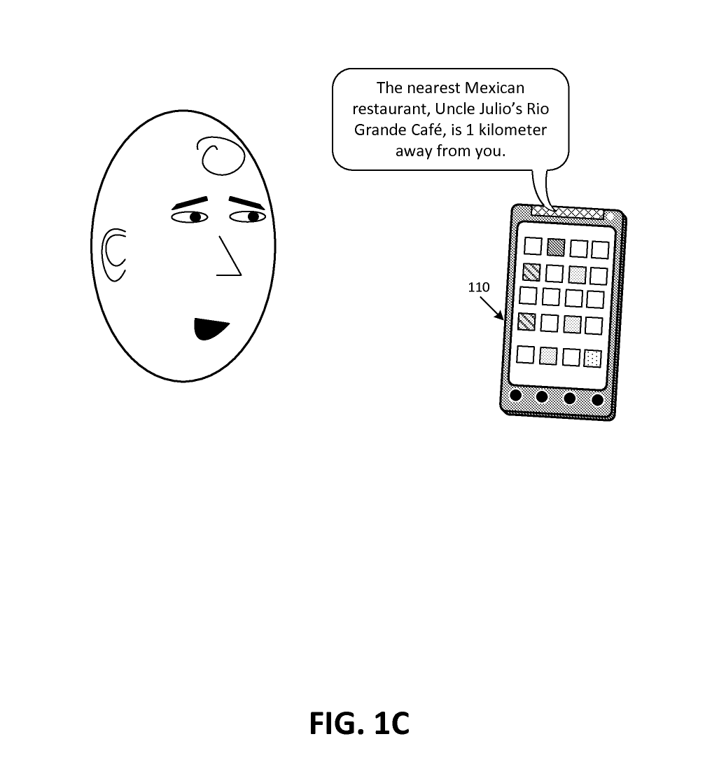

FIG. 2 is a diagram of an example environment 200 in which systems and/or methods described herein may be implemented. Environment 200 may include user device 205, place of interest dialog system 210, and search engine server 215 connected to network 220. Place of interest dialog system 210 may be a server. One user device 205 and two servers 210 and 215 have been illustrated as connected to network 220 for simplicity. In practice, environment 200 may include additional user devices and/or servers or fewer user devices and/or servers. Also, in some instances, a user device may perform a function of a server, or a server may perform a function of a user device.

User device 205 may implement one or more functions of user device 110. User device 205 may include a client device, such as a mobile telephone, a personal computer, a personal digital assistant (“PDA”), a tablet computer, a laptop, or any other type of computation or communication device. User device 205 may include audio input/output devices that allow a user to communicate with user device 205 via speech. For example, these audio input/output devices may include one or more microphones and/or one or more speakers. User device 205 may also include one or more visual input/output devices, such as one or more cameras and/or one or more display screens that are capable of presenting a user interface via which a user may interact.

Servers 210 and 215 may each be implemented as a single server device or a collection of server devices that may be co-located or remotely located. Additionally, or alternatively, servers 210 and 215 may be implemented together within a single, common server device or a single, common collection of server devices.

Place of interest dialog system 210 may communicate with user device 205, and may determine that a request is classified as a place-triggering request, e.g., classify questions received by user device 205. As further described below, place of interest dialog system 210 may further identify categories associated with the place-triggering requests. In order to identify the categories, place of interest dialog system 210 may extract information from one or more information sources, such as web pages that include restaurant reviews, official business web pages, knowledge repositories, and/or any other information sources. Place of interest dialog system 210 may store information associating phrases extracted from the information sources to categories. Place of interest dialog system 210 may compare phrases in received requests to these categories in order to identify categories associated with the phrases.

Place of interest dialog system 210 may use an identification of a category associated with a request in order to provide a response to the request. For example, place of interest dialog system 210 may communicate with search engine server 215 to identify one or more documents that are associated with the request and/or the associated category. Place of interest dialog system 210 may output information regarding the identified one or more documents to user device 205 as a response to a request, e.g., an answer to a question.

Search engine server 215 may implement a search engine that receives queries, e.g., from client 205 and/or from place of interest dialog system 210. Search engine server 215 may provide one or more search results in response to the received queries. The search results may include information regarding one or more documents, such as a link to the one or more documents. A document may include, for example, a web site, a file, a combination of files, one or more files with embedded links to other files, a news group posting, a news article, a blog, a business listing, an electronic version of printed text, a web advertisement, and an e-mail. In the context of the Internet, a common document is a web page. Documents often include textual information and may include embedded information, such as meta information, images, hyperlinks, and/or embedded instructions, such as Javascript.

Additional servers, implementing other functions, may also be implemented in environment 200. For example, environment 200 may include a log server that stores information regarding input received from users by user device 205, a log server that stores information regarding output provided by user device 205, and/or any other server. The additional servers may additionally, or alternatively, provide, for example, web content, payment services, shopping services, and social networking services.

Network 220 may include any type of network, such as a local area network (“LAN”), a wide area network (“WAN”), a telephone network—e.g., the Public Switched Telephone Network (“PSTN”) or a cellular network—an intranet, the Internet, or a combination of networks. User device 205, place of interest dialog system 210, and/or search engine server 215 may connect to network 220 via wired and/or wireless connections. In other words, user device 205, place of interest dialog system 210, and/or search engine server 215 may connect to network 220 via a wired connection, a wireless connection, or a combination of a wired connection and a wireless connection.

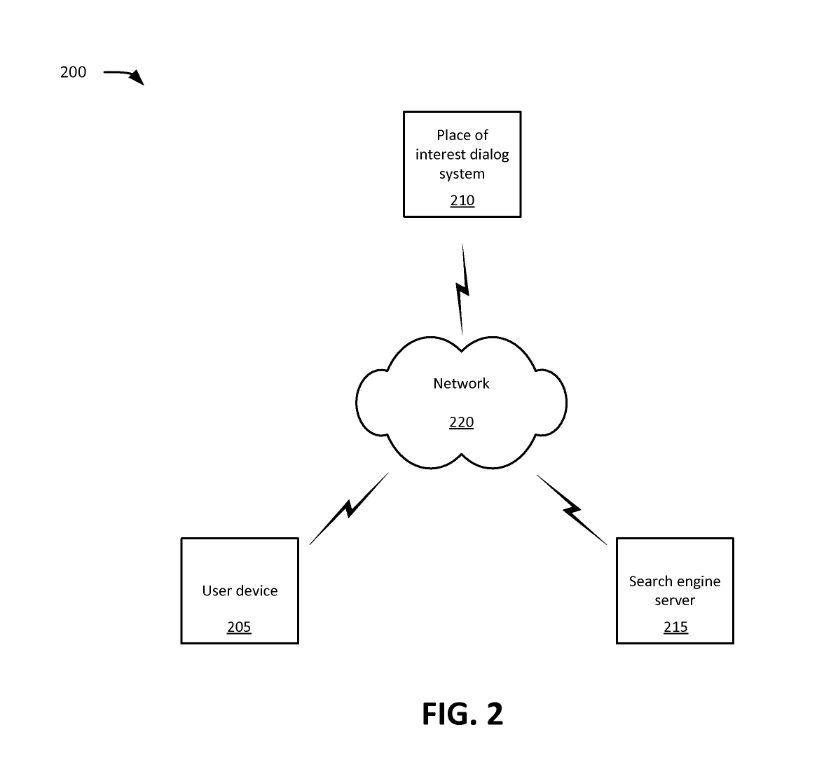

FIG. 3 shows an example of generic computing device 300 and generic mobile computing device 350, which may be used with the techniques described here. Computing device 300 and mobile computing device 350 may correspond to, for example, any of user device 205, place of interest dialog system 210, and/or search engine server 215. Each of user device 205, place of interest dialog system 210, and/or search engine server 215 may include one or more computing devices 300, mobile computing devices 350, or components of computing device 300 and/or mobile computing device 350.

Computing device 300 is intended to represent various forms of digital computers, such as laptops, desktops, workstations, personal digital assistants, servers, blade servers, mainframes, and other appropriate computers. Mobile computing device 350 is intended to represent various forms of mobile devices, such as personal digital assistants, cellular telephones, smart phones, and other similar computing devices. The components shown in FIG. 3, their connections and relationships, and their functions, are meant to be examples only, and are not meant to limit implementations described and/or claimed in this document.

Computing device 300 may include a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. Processor 302 can process instructions for execution within the computing device 300, including instructions stored in the memory 304 or on the storage device 306 to display graphical information for a graphical user interface (“GUI”) on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations, e.g., as a server bank, a group of blade servers, or a multi-processor system.

Memory 304 stores information within the computing device 300. In some implementations, memory 304 includes a volatile memory unit or units. In some implementations, memory 304 includes a non-volatile memory unit or units. The memory 304 may also be another form of computer-readable medium, such as a magnetic or optical disk. A computer-readable medium may be defined as a non-transitory memory device. A memory device may include space within a single physical memory device or spread across multiple physical memory devices.

Storage device 306 is capable of providing mass storage for the computing device 300. In some implementations, storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or memory on processor 302.

High speed controller 308 manages bandwidth-intensive operations for the computing device 300, while low speed controller 312 manages lower bandwidth-intensive operations. Such allocation of functions is exemplary only. In some implementations, high-speed controller 308 is coupled to memory 304, display 316, e.g., through a graphics processor or accelerator, and to high-speed expansion ports 310, which may accept various expansion cards. In this implementation, low-speed controller 312 is coupled to storage device 306 and low-speed expansion port 314. The low-speed expansion port, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

Computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device, such as mobile computing device 350. Each of such devices may contain one or more of computing devices 300, 350, and an entire system may be made up of multiple computing devices 300, 350 communicating with each other.

Mobile computing device 350 may include a processor 352, memory 364, an input/output (“I/O”) device such as a display 354, a communication interface 366, and a transceiver 368, among other components. Mobile computing device 350 may also be provided with a storage device, such as a micro-drive or other device, to provide additional storage. Each of the components 350, 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a Thin-Film-Transistor Liquid Crystal Display (“TFT LCD”) or an Organic Light Emitting Diode (“OLED”) display, or other appropriate display technology. Display interface 356 may include appropriate circuitry for driving display 354 to present graphical and other information to a user. Control interface 358 may receive commands from a user and convert them for submission to the processor 352. In addition, an external interface 362 may be in communication with processor 352, so as to enable near area communication of mobile computing device 350 with other devices. External interface 362 may provide, for example, for wired communication in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a Single In Line Memory Module (“SIMM”) card interface. Such expansion memory 374 may provide extra storage space for device 350, or may also store applications or other information for mobile computing device 350. Specifically, expansion memory 374 may include instructions to carry out or supplement the processes described above, and may include secure information also. Thus, for example, expansion memory 374 may be provide as a security module for mobile computing device 350, and may be programmed with instructions that permit secure use of device 350. In addition, secure applications may be provided via the SIMM cards, along with additional information, such as placing identifying information on the SIMM card in a non-hackable manner.

Expansion memory 374 may include, for example, flash memory and/or NVRAM memory. In some implementations, a computer program product is tangibly embodied in an information carrier. The computer program product contains instructions that, when executed, perform one or more methods, such as those described above. The information carrier is a computer-or machine-readable medium, such as the memory 364, expansion memory 374, or memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver. In addition, Global Positioning System (“GPS”) receiver module 370 may provide additional navigation- and location-related wireless data to mobile computing device 350, which may be used as appropriate by applications running on mobile computing device 350.

Mobile computing device 350 may also communicate audibly using audio codec 360, which may receive spoken information from a user and convert it to usable digital information. Audio codec 360 may likewise generate audible sound for a user, such as through a speaker, e.g., in a handset of mobile computing device 350. Such sound may include sound from voice telephone calls, may include recorded sound, e.g., voice messages and music files, and may also include sound generated by applications operating on mobile computing device 350.

Mobile computing device 350 may be implemented in a number of different forms, as shown in the figure. For example, it may be implemented as a cellular telephone 380. It may also be implemented as part of a smart phone 382, personal digital assistant, or other similar mobile device.

Various implementations of the systems and techniques described herein can be realized in digital electronic circuitry, integrated circuitry, specially designed application specific integrated circuits (“ASICs”), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” and “computer-readable medium” refer to any non-transitory apparatus and/or device, e.g., magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device, e.g., a cathode ray tube (“CRT”) or liquid crystal display (“LCD”) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described herein can be implemented in a computing system that includes a back end component, e.g., as a data server, or that includes a middleware component, e.g., an application server, or that includes a front end component, e.g., a client computer having a graphical user interface or a Web browser through which a user can interact with implementations of the systems and techniques described here, or any combination of such back end, middleware, or front end components. The components of the system can be interconnected by any form or medium of digital data communication, e.g., a communication network. Examples of communication networks include a LAN, a WAN, and the Internet.

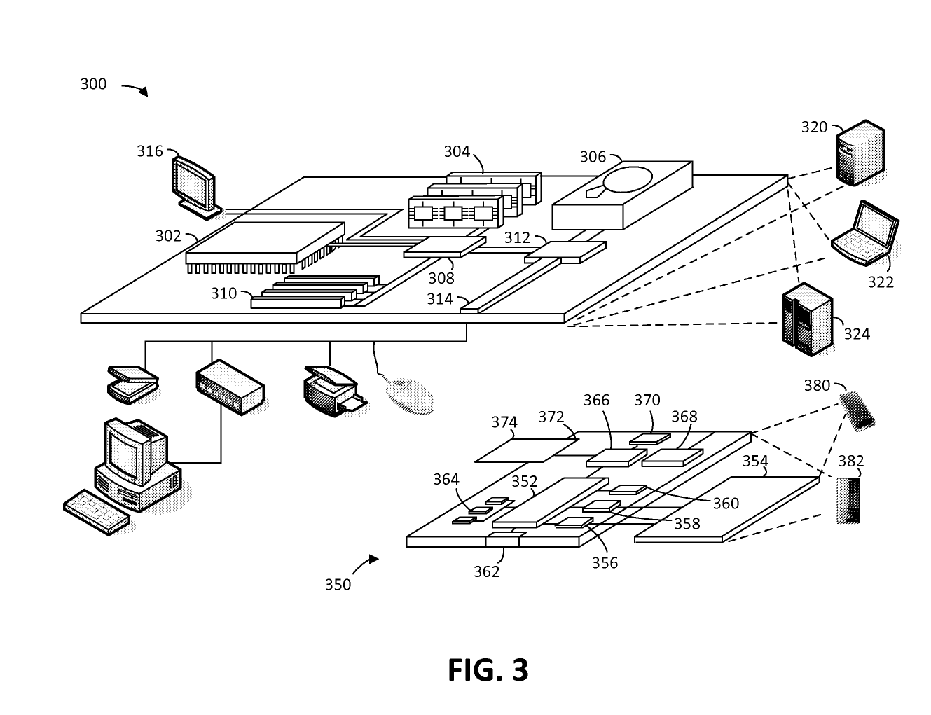

FIG. 4 illustrates example functional components of an example system 400. System 400 may correspond to, for instance, some or all of the functional components of place of interest dialog system 210. As shown in FIG. 4, system 400 may include modules 405-415. In some implementations, system 400 may include fewer, additional, or different modules. Any, or all, of modules 405-415 may be implemented by one or more memory devices, such as memory 304 and/or memory 364, and/or one or more processors, such as processor 308 and/or processor 352. Furthermore, multiple modules may be associated with the same memory device and/or processor. For example, one memory device, or one set of memory devices, may store information associated with two or more of modules 405-415.

Category identification engine 405 may receive information regarding places of interest. Category identification engine 405 may receive the information from one or more information sources, such as web sites that include reviews of businesses, listings of geographical locations, or any information source that includes information regarding locations of interest. The information received by category identification engine 405 may include, for example, information provided by proprietors of businesses; information automatically generated and/or extracted by one or more document analysis engines, e.g., one or more devices that analyze documents and identify information associated with the documents, such as topics and/or categories associated with the documents; information manually provided by users, e.g., restaurant reviews; and/or any type of information.

Category identification engine 405 may identify one or more categories associated with a particular document. For example, assume that category identification engine 405 identifies a document that includes reviews of a Mexican restaurant. Category identification engine 405 may identify that a category associated with the document is “Mexican restaurant.” In some implementations, the document may include information that specifically indicates that the category associated with the document is “Mexican restaurant.” For example, the document may include text, such as “category: Mexican restaurant,” “tags: Mexican restaurant,” or the like. Additionally, or alternatively, the document may include meta-data that indicates that the category associated with the document is “Mexican restaurant.” Additionally, or alternatively, category identification engine 405 may identify the category based on terms that frequently appear in the document.

N-gram categorization engine 410 may extract phrases, or n-grams, from information regarding places of interest. Continuing with the above example, n-gram categorization engine 410 may extract n-grams from the web page that includes reviews of the Mexican restaurant. An n-gram may include a phrase with N words, where N is an integer that is greater than or equal to 1—e.g., 3 words, 4 words, or any other quantity of words. In some implementations, an n-gram may include words that appear contiguously in the document. For example, assume that a document includes the phrase “The rice and beans were great.” Further assume that n-gram categorization engine 410 extracts tri-grams—that is, n-grams where N=3. N-gram categorization engine 410 may extract the following tri-grams based on the above phrase: “the rice and,” “rice and beans,” “and beans were,” and “beans were great.”

In some implementations, n-gram categorization engine 410 may exclude insignificant terms, such as stop words—e.g., “and,” “or,” “the,” “of,” “is,” “was,” and “were”—when extracting n-grams. In some such implementations, and referring to the above example phrase, n-gram categorization engine 410 may extract the tri-gram “rice beans great” from the phrase “The rice and beans were great.”

In some implementations, n-gram categorization engine 410 may extract n-grams with varying values of N from a particular document. In some such implementations, and referring to the above example phrase, n-gram categorization engine 410 may extract the bi-grams “the rice,” “rice and,” “and beans,” “beans were,” and “were great,” the tri-grams “the rice and,” “rice and beans,” “and beans were,” and “beans were great,” the quad-grams “the rice and beans,” “rice and beans were,” and “and beans were great.”

In some implementations, when extracting n-grams, n-gram categorization engine 410 may identify stems of words, and replace words that are based on the stems of the words with the stems of the words. For example, the word “beans” may be associated with the stem “bean.” In some such implementations, and referring to the above example phrase, n-gram categorization engine 410 may extract the tri-gram “rice and bean.”

As another example, and according to such implementations, the words “running,” “runs,” and “ran,” may be associated with the stem “run.” Assume, for example, that n-gram categorization engine 410 identifies the phrase “They ran around without believing a word I said.” N-gram categorization engine 410 may extract the example bi-grams “they run,” “without believe,” “I say.”

In some implementations, n-gram categorization engine 410 may extract n-grams based on stems of words in addition to, or in lieu of, extracting n-grams based on words that are based on stems. For example, referring to the example phrase “They ran around without believing a word I said,” n-gram categorization engine 410 may extract the example bi-grams “they run” in lieu of, or in addition to, extracting the bi-gram “they ran.”

N-gram categorization engine 410 may associate some or all of the extracted n-grams with one or more categories. For example, n-gram categorization engine 410 may generate or modify category scores, which may reflect how strongly n-grams are related to categories. Assume, for instance, that n-gram categorization engine 410 receives information from n-gram category repository 415 indicating that a category score for the bi-gram “rice beans” and the category “Mexican restaurant” is 0.8. Based on identifying that the category for the document is “Mexican restaurant,” and that the bi-gram was extracted from the document, n-gram categorization engine 410 may modify the category score of 0.8. For example, n-gram categorization engine 410 may increase the category score based on identifying that the category for the document is “Mexican restaurant,” and that the bi-gram was extracted from the document. Thus, a category score for a particular n-gram and a particular category may be based on a quantity of instances of identifying that the particular n-gram is associated with the particular category—e.g., identifying that the particular n-gram was extracted from a document associated with the particular category. N-gram categorization engine 410 may output the generated or modified category scores to a repository, such as n-gram category repository 415.

When associating an n-gram with a category, n-gram categorization engine 410 may identify that multiple categories, associated with the n-gram, are related. For example, assume that n-gram categorization engine 410 receives information from n-gram category repository 415 indicating that the n-gram “rice beans” is associated with the categories “Mexican restaurant” and “Mexican cuisine.” N-gram categorization engine 410 may identify that these categories are similar using any similarity detection technique, such as edit distance, hamming distance, semantic similarity analysis, word stem analysis, and/or any other similarity detection technique. N-gram categorization engine 410 may select one of these similar categories as a category that represents multiple similar categories.

For example, n-gram categorization engine 410 may select the category “Mexican restaurant” to represent the categories “Mexican restaurant” and “Mexican cuisine.” N-gram categorization engine 410 may select the category “Mexican restaurant” using any criteria, such as, for example, respective category scores associated with the n-gram and the categories “Mexican restaurant” and “Mexican cuisine.” For instance, n-gram categorization engine 410 may select the category “Mexican restaurant” as the representative category based on identifying that the category score associated with the category “Mexican restaurant” and the n-gram is greater than the category score associated with the category “Mexican cuisine” and the n-gram.

N-gram categorization engine 410 may generate or modify a category score for a category that is selected as representative of multiple categories. Continuing with the above example, assume that the category score associated with the category “Mexican restaurant” and the n-gram is 0.8, and that the category score associated with the category “Mexican cuisine” and the n-gram is 0.7. N-gram categorization engine 410 may modify the category score for the category “Mexican restaurant”—i.e., 0.8—by an amount that is based on 0.7. For example, N-gram categorization engine 410 may increase or decrease the score of 0.8 by an amount that is based on 0.7. In some implementations, n-gram categorization engine 410 may generate or modify a category score by calculating an average of 0.7 and 0.8, a median of 0.7 and 0.8, a minimum of 0.7 and 0.8, a maximum of 0.7 and 0.8, and/or by performing any other operation based on 0.7 and 0.8. In some implementations, n-gram categorization engine 410 may associate the generated or modified score with the representative category. In some implementations, n-gram categorization engine 410 may associate the generated or modified score with one or more categories associated with the representative categories—e.g., the categories “Mexican restaurant” and “Mexican cuisine” in the above example. N-gram categorization engine 410 may provide the generated or modified scores to a repository, such as n-gram category repository 415.

N-gram categorization engine 410 may associate categories with n-grams. Continuing with the above example, n-gram categorization engine 410 may associate the category “Mexican restaurant” with the n-gram “rice beans.” When associating the category “Mexican restaurant” with the n-gram “rice beans,” n-gram categorization engine 410 may identify multiple categories associated with the n-gram “rice beans,” and may select the category “Mexican restaurant” out of the identified categories. N-gram categorization engine 410 may select the category based on any criteria, including, for example, category scores associated with the n-gram and the respective categories.

For example, assume that n-gram categorization engine 410 identifies that a category score for the category “Mexican restaurant” and the n-gram “rice beans” is 0.8, and that a category score for the category “farms” and the n-gram “rice beans” is 0.1. N-gram categorization engine 410 may select the category “Mexican restaurant” for the n-gram “rice beans” based on identifying that the category score for the category “Mexican restaurant” and the n-gram “rice beans” is greater than the category score for the category “farms” and the n-gram “rice beans.” N-gram categorization engine 410 may output information associating the n-gram “rice beans” with the category “Mexican restaurant” to a repository, such as n-gram category repository 415.

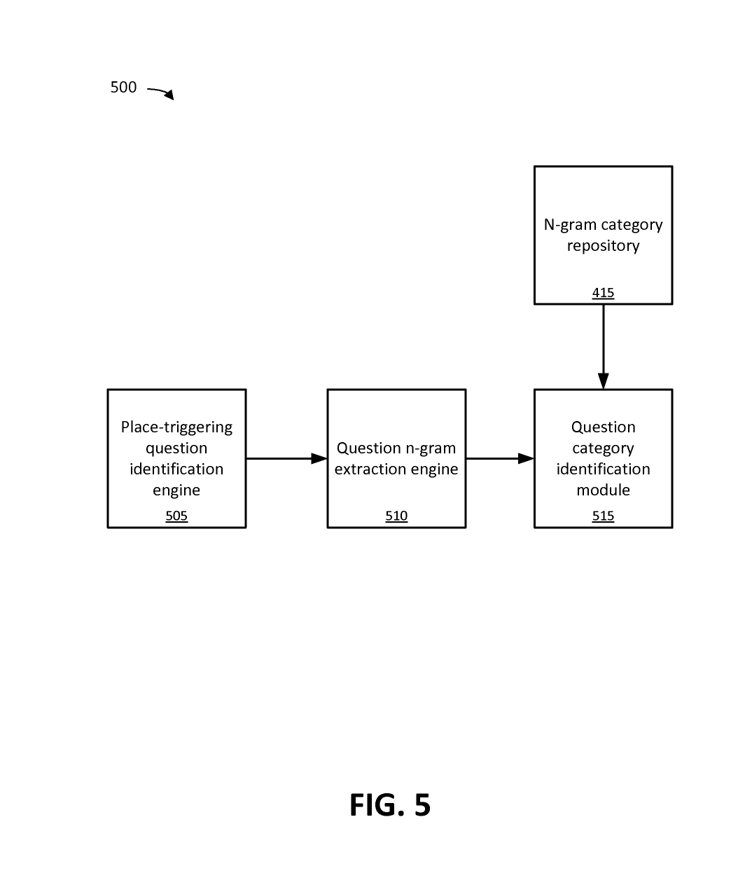

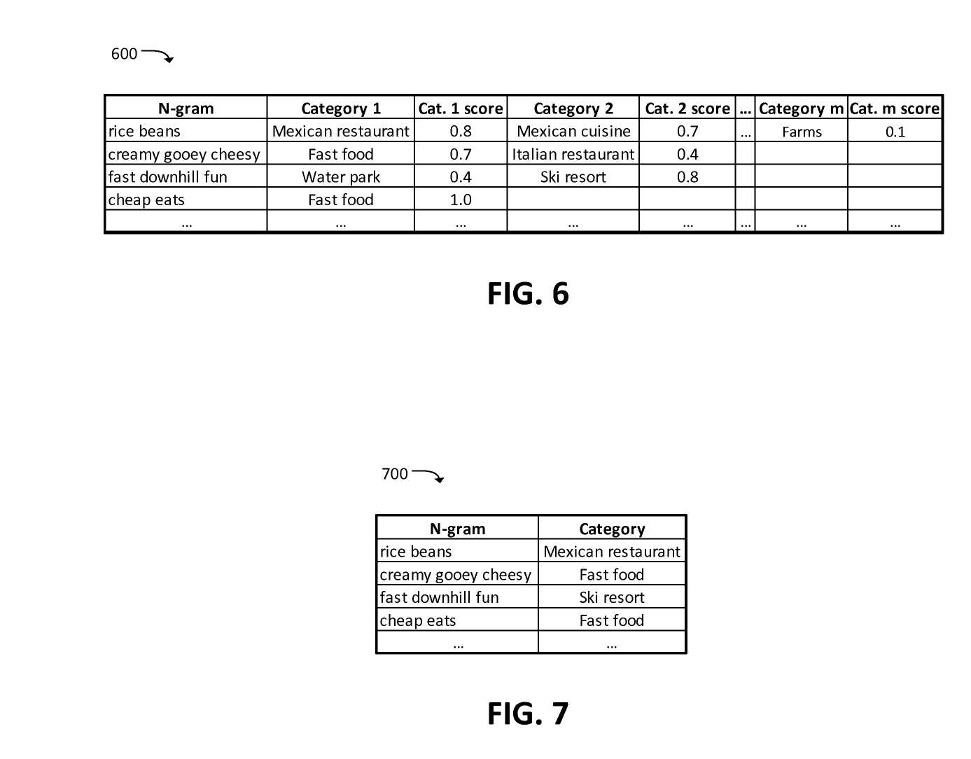

N-gram category repository 415 may store information associating n-grams with categories and respective category scores. FIGS. 6 and 7, described below, illustrate example data structures that may be stored by n-gram category repository 415.

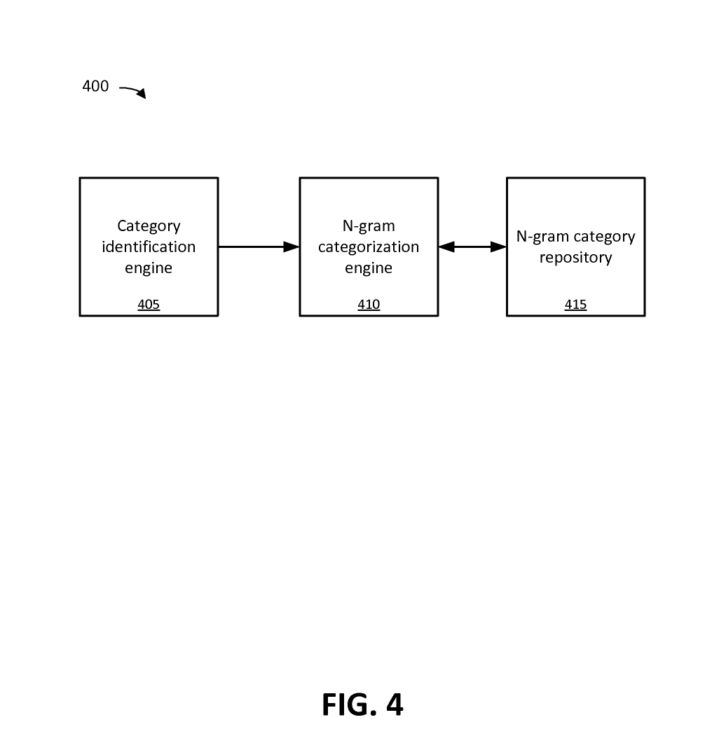

FIG. 5 illustrates example functional components of an example system 500 where a request is a question. System 500 may correspond to, for instance, some or all of the functional components of place of interest dialog system 210. As shown in FIG. 5, system 500 may include modules 415 and 505-515. In some implementations, system 500 may include fewer, additional, or different modules. Any, or all, of modules 415 and 505-515 may be implemented by one or more memory devices, such as memory 304 and/or memory 364, and/or one or more processors, such as processor 308 and/or processor 352. Furthermore, multiple modules may be associated with the same memory device and/or processor. For example, one memory device, or one set of memory devices, may store information associated with two or more of modules 415 and 505-515.

Place-triggering question identification engine 505 may receive a question from, for example, a user device—e.g., user device 205—and may classify or determine that the question is classified as a place-triggering question. In other words, place-triggering question identification engine 505 may determine that the question is classified as a question for which system 500 will select one or more places of interest to provide an answer.

In some implementations, place-triggering question identification engine 505 may not only determine that a question is classified as a place-triggering question, but may also classify a question as a place-triggering question. In order to classify a request as a place-triggering request, place-triggering question identification engine 505 may determine whether the question includes one or more terms from a list of terms that are associated with place-triggering questions. The list of terms may include, for example, “where,” “place,” “I need,” “I want,” “location,” “here,” “near,” and “nearby.”

In some implementations, place-triggering question identification engine 505 may determine whether one or more terms in the question are an exact match of one or more terms in the list of terms associated with place-triggering questions. For example, assume that the list of terms includes the term “near,” and that the question also includes the term “near.” In this example, and according to these implementations, place-triggering question identification engine 505 may classify the question as a place-triggering question based on identifying that the question includes a term that is an exact match of a term from the list of terms that are associated with place-triggering questions. As another example, assume that the list of terms includes the term “nearby,” and that the question includes the term “near.” In some such implementations, place-triggering question identification engine 505 may classify the question as not a place-triggering question, based on identifying that the question does not include a term that is an exact match of a term from the list of terms that are associated with place-triggering questions.

In some implementations, place-triggering question identification engine 505 may determine whether one or more terms in the question are similar, beyond a similarity threshold, to one or more terms in the list of terms associated with place-triggering questions. When determining a similarity of the one or more terms of the question to the one or more terms in the list of terms associated with place-triggering questions, place-triggering question identification engine 505 may use one or more of a variety of similarity detection techniques. For example, place-triggering question identification engine 505 may determine an edit distance, a hamming distance, a semantic similarity, and/or may use any other technique for determining a similarity of the one or more terms of the question to the one or more terms in the list of terms associated with place-triggering questions.

For example, assume that the list of terms includes the term “nearby,” and that the question includes the term “near.” In some such implementations, place-triggering question identification engine 505 may classify the question as a place-triggering question based on identifying that the question includes a term that is similar to a term from the list of terms that are associated with place-triggering questions, even though the term is not an exact match of a term from the list of terms that are associated with place-triggering questions.

While some examples of how place-triggering question identification engine 505 may determine whether a question is classified as a place-triggering question are described above, place-triggering question identification engine 505 may use any technique to determine whether a question is classified as a place-triggering question. For example, place-triggering question identification engine 505 may receive information that identifies a question is classified as a place-triggering questions from, e.g., one or more devices that analyze logs of questions and/or answers provided in response to questions to identify place-triggering questions. As another example, place-triggering question identification engine 505 may use a semantic analysis technique to determine whether a question is classified as a place-triggering question.

Place-triggering question identification engine 505 may output an indication of whether a particular question is classified as a place-triggering question to one or more devices. For example, place-triggering question identification engine 505 may output information regarding questions that are classified as place-triggering questions to question n-gram extraction engine 510. Additionally, or alternatively, place-triggering question identification engine 505 may output information regarding whether questions are classified as place-triggering questions to one or more devices that store logs.

Question n-gram extraction engine 510 may receive questions, such as questions that were classified as place-triggering questions, and extract n-grams from the received questions. For example, assume that question n-gram extraction engine 510 receives the place-triggering question “Where can I get some rice and beans?” Further assume that question n-gram extraction engine 510 extracts tri-grams from received questions. In this example, question n-gram extraction engine 510 may extract the following n-grams: “where can I,” “can I get,” “some rice and,” and “rice and beans.”

In some implementations, question n-gram extraction engine 510 may exclude insignificant terms, such as stop words—e.g., “and,” “or,” “the,” “of,” “is,” “was,” and “were”—when extracting n-grams from questions. In some such implementations, and referring to the above example question, question n-gram extraction engine 510 may extract the tri-grams “where can I,” “can I get,” and “some rice beans” from the question “Where can I get some rice and beans?”

In some implementations, question n-gram extraction engine 510 may extract n-grams with varying values of N from a particular question. In some such implementations, and referring to the above example question, question n-gram extraction engine 510 may extract the bi-grams “where can,” “can I,” “I get,” “get some,” “some rice,” “rice and,” and “and beans” the tri-grams “where can I,” “can I get,” “I get some,” “get some rice,” “some rice and,” and “rice and beans,” the quad-grams “where can I get,” “can I get some,” “I get some rice,” “get some rice and,” and “some rice and beans.”

In some implementations, question n-gram extraction engine 510 may exclude terms associated with place-triggering questions when extracting n-grams from a particular question. For example, assume that the phrase “where can I” is associated with place-triggering questions. In some such implementations, and referring to the above example question, question n-gram extraction engine 510 may extract the n-grams “get some rice,” “some rice and,” and “rice and beans.”

In some implementations, when extracting n-grams, question n-gram extraction engine 510 may identify stems of words, and replace words that are based on the stems of the words with the stems of the words. For example, the word “beans” may be associated with the stem “bean.” In some such implementations, and referring to the above example question, question n-gram extraction engine 510 may extract the tri-gram “rice and bean.”

Question category identification module 515 may receive n-grams extracted from a question from, e.g., question n-gram extraction engine 510, and may identify, based on the n-grams, a category of places of interest associated with the question. In order to identify a category associated with a question, question category identification module 515 may compare n-grams, extracted from the question, to information that associates n-grams with categories. Such information may be received from, for example, n-gram category repository 415. Continuing with the above example question, assume that question category identification module 515 receives “get some rice,” “some rice beans,” and “rice and beans,” and “rice beans.” Further assume that n-gram category repository 415 receives information indicating that the n-gram “rice beans” is associated with the category “Mexican restaurant.” Question category identification module 515 may identify that the question is associated with the category “Mexican restaurant,” based on identifying that the question includes the n-gram “rice beans,” which is associated with the category “Mexican restaurant.”

In some implementations, question category identification module 515 may determine whether one or more n-grams extracted from a question are an exact match of one or more n-grams included in information associating n-grams with categories. In some implementations, question category identification module 515 may determine whether one or more n-grams extracted from a question are similar, beyond a similarity threshold, to one or more n-grams included in information associating n-grams with categories. Some examples of techniques that question category identification module 515 may use in identifying similar n-grams are described above with respect to place-triggering question identification engine 505.

Question category identification module 515 may output information associating the question with the particular category to one or more devices. For example, question category identification module 515 may output the information to user device 205, search engine server 215, one or more devices that store logs regarding categories associated with questions, and/or to any other device.

In some instances, question category identification module 515 may identify that a particular question is not associated with a particular category. For example, question category identification module 515 may fail to identify any n-grams, extracted from the particular question, that are identical or similar to n-grams that are associated with categories. In some implementations, when such a scenario occurs, question category identification module 515 may output information indicating that the question is not associated with a category. For example, question category identification module 515 may output such information to user device 205, search engine server 215, one or more devices that store logs regarding categories associated with questions, and/or to any other device. In some implementations, question category identification module 515 may forego outputting information indicating that the question is not associated with a category.

In some situations, a particular question may be associated with multiple categories. In some implementations, question category identification module 515 may output information that indicates that the question is associated with the multiple categories. In some implementations, question category identification module 515 may select fewer than all of the multiple categories—e.g., one category—to associate with the question, based on any criteria. For example, question category identification module 515 may compare a relevance of the category to one or more terms of the question, and may select a most relevant category. In some implementations, question category identification module 515 may forego selecting a category to associate with the question. That is, in some such implementations, when a question is associated with multiple categories, question category identification module 515 may output information indicating that the question is not associated with a particular category.

The information, outputted by question category identification module 515, may be used in a variety of ways. For example, the information outputted by question category identification module 515 may include a request to search engine server 215 to execute a search based on a category associated with a particular question. Continuing with the above example, assume that question category identification module 515 associates the category “Mexican restaurants” with the question “Where can I get some rice and beans?” Question category identification module 515 may output a request to search engine server 215 to execute a search based on the phrase “Mexican restaurants.”

In some implementations, the request outputted by question category identification module 515 may request that search engine server 215 execute the search based on one or more other criteria. For example, search engine server 215 may receive information regarding a geographic location associated with user device 205, and may execute the search further based on the geographic location associated with user device 205. For example, search engine server 215 may receive information indicating that user device 205 is located in Fairfax, Va. In this example, search engine server 215 may execute a search based on the phrase “Mexican restaurants Fairfax, Va.”

In some implementations, the request outputted by question category identification module 515 may include some or all of the question in addition to the category. For example, the request outputted by question category identification module 515 may request that search engine server 215 execute a search based on the phrase “rice beans Mexican restaurants.”

Search engine server 215 may identify a set of search results in response to executing a search query that is based on a request outputted by question category identification module 515. Search engine server 215 may output one or more of these results to one or more devices, such as user device 205, and/or to one or more devices that analyze the one or more results in order to provide an answer to user device 205.

FIG. 6 illustrates an example data structure 600 that may be stored by, for example, n-gram category repository 415. Data structure 600 may store information associating n-grams with categories, and respective associated category scores. For example, as shown in FIG. 6, data structure 600 may store information associating the n-gram “rice beans” with categories 1-m, where m is an integer that is greater than 1—i.e., the categories “Mexican restaurant,” “Mexican cuisine,” and “Farms.” Data structure 600 may also store category scores associated with respective n-grams and categories. For example, as shown in FIG. 6, the category “Mexican restaurant” may be associated with a category score of 0.8 with respect to the n-gram “rice beans,” the category “Mexican cuisine” may be associated with a category score of 0.7 with respect to the n-gram “rice beans,” and the category “Farms” may be associated with a category score of 0.1 with respect to the n-gram “rice beans.”

As shown in FIG. 6, a particular category may be associated with multiple different category scores for multiple different n-grams. For example, the category “Fast food” may be associated with a category score of 0.7 with respect to the n-gram “creamy gooey cheesy,” and the same category “Fast food” may be associated with a category score of 1.0 with respect to the n-gram “cheap eats.”

FIG. 7 illustrates an example data structure 700 that may be stored by, for example, n-gram category repository 415. Data structure 700 may store information associating n-grams with categories, such as categories selected as being representative of the n-grams. As discussed above, n-gram categorization engine 410 may identify categories that are representative of n-grams. In the example shown in FIG. 7, the n-gram “rice beans” may be associated with the representative category “Mexican restaurant,” the n-gram “creamy gooey cheesy” may be associated with the representative category “Fast food,” the n-gram “fast downhill fun” may be associated with the representative category “Ski resort,” and the n-gram “cheap eats” may be associated with the representative category “Fast food.”

While data structures 600 and 700 are represented in FIGS. 6 and 7, respectively, as including tables with rows and columns, in practice, data structures 600 and 700 may include any type of data structure, such as a linked list, a tree, a hash table, a database, or any other type of data structure. Data structures 600 and/or 700 may include information generated by and/or received from one or more devices, such as one or more functional components described above with respect to FIGS. 4 and/or 5. Additionally, or alternatively, data structures 600 and/or 700 may include information provided from any other source, such as information provided by one or more users, and/or information automatically provided by one or more other devices. Furthermore, in some implementations, one or more of data structures 600 and/or 700 may include additional, different, or less information than the information shown in FIGS. 6 and 7.

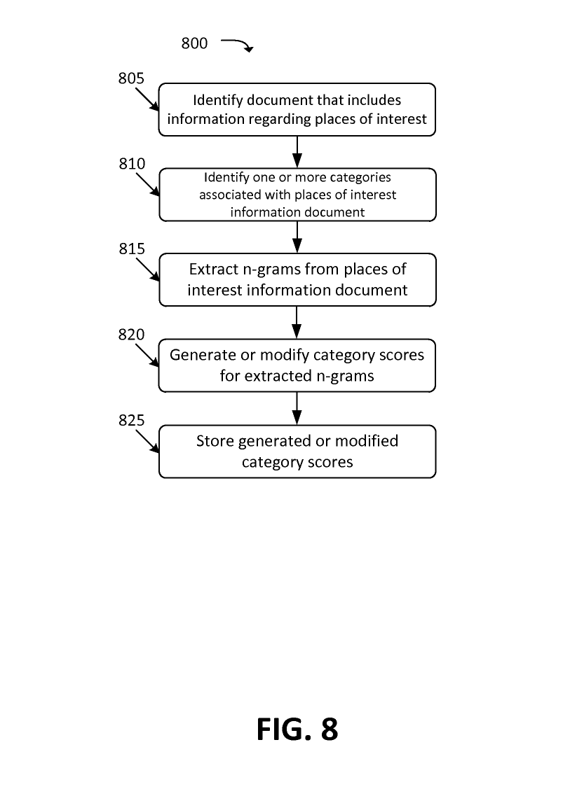

FIG. 8 illustrates a flowchart of an example process 800 for generating or modifying category scores of n-grams extracted from documents that include information regarding places of interest. In some implementations, process 800 may be performed by one or more components of place of interest dialog system 210. In some implementations, some or all of process 800 may be performed by one or more other components instead of, or possibly in conjunction with, place of interest dialog system 210. For example, in some implementations, some or all of process 800 may be performed by user device 205.

Process 800 may include identifying a document that includes information regarding places of interest (block 805). For example, as described above with respect to category identification engine 405, place of interest dialog system 210 may identify a document from one or more information sources, such as web sites that include reviews of businesses, listings of geographical locations, or any information source that includes information regarding locations of interest.

Process 800 may also include identifying one or more categories associated with the places of interest information document (block 810). For example, as described above with respect to category identification engine 405, place of interest dialog system 210 may identify one or more categories associated with the document identified at block 805. As described above, for example, content of the document may include information identifying the one or more categories, meta-data associated with the document may include information identifying the one or more categories, place of interest dialog system 210 may identify the one or more categories based on terms that appear frequently within the document.

Process 800 may further include extracting n-grams from the places of interest information document (block 815). For example, as described above with respect to n-gram categorization engine 410, place of interest dialog system 210 may extract n-grams from the document identified at block 805. As described above, in some implementations, place of interest dialog system 210 may extract n-grams of a single length—e.g., only bi-grams, only tri-grams—from the places of interest information document. In some implementations, place of interest dialog system 210 may extract n-grams of multiple lengths—e.g., bi-grams and tri-grams; bi-grams and quad-grams; bi-grams, tri-grams, and quad-grams—from the places of interest information document. In some implementations, place of interest dialog system 210 may omit insignificant words, such as stop words, when extracting n-grams from the places of interest information document. In some implementations, as also described above, place of interest dialog system 210 may extract stems of words in addition to, or in lieu of, extracting actual words that appear in the places of interest information document.

Process 800 may additionally include generating or modifying category scores for the extracted n-grams (block 820). For example, as described above with respect to n-gram categorization engine 410, place of interest dialog system 210 may generate or modify category scores for some or all the n-grams extracted at block 815. Place of interest dialog system 210 may, for example, generate category scores associated with the n-grams and the category identified at block 810. The category score for a particular n-gram and a particular category may reflect, for example, a quantity of times that the particular n-gram was extracted from a places of interest information document that is associated with the particular category. Additionally, or alternatively, the category score for a particular n-gram and a particular category may reflect, for example, one or more of a ratio of identified places of interest information documents from which the particular n-gram was extracted, a quantity of identified places of interest information documents from which the particular n-gram was extracted, a quantity of occurrences of a particular n-gram in a particular places of interest information document.

Process 800 may further include storing the generated or modified category scores (block 825). For example, as described above with respect to n-gram category repository 415, place of interest dialog system 210 may store the category scores generated or modified at block 820 using, for example, data structure 600.

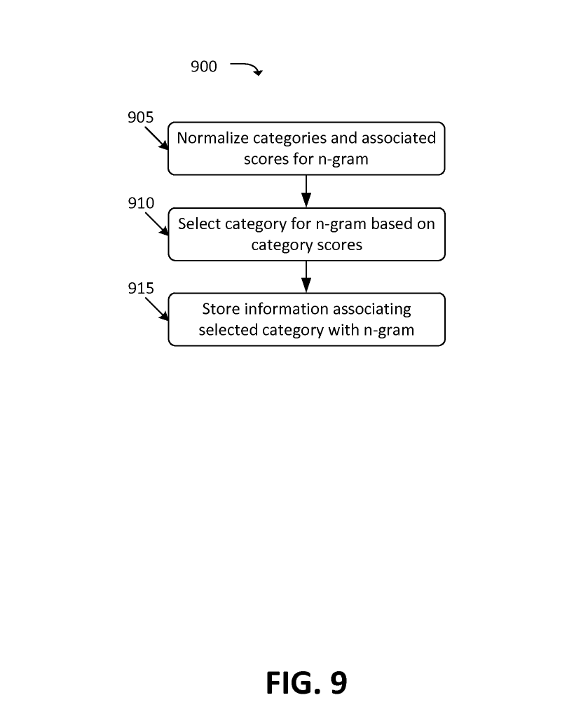

FIG. 9 illustrates a flowchart of an example process 900 for categorizing n-grams associated with places of interest. In some implementations, process 900 may be performed by one or more components of place of interest dialog system 210. In some implementations, some or all of process 900 may be performed by one or more other components instead of, or possibly in conjunction with, place of interest dialog system 210. For example, in some implementations, some or all of process 900 may be performed by user device 205.

Process 900 may include normalizing categories and associated scores for an n-gram, such as an n-gram stored by a repository, such as n-gram category repository 415 (block 905). For example, as described above with respect to n-gram categorization engine 410, when normalizing categories, place of interest dialog system 210 may identify that the n-gram is associated with multiple related categories. Place of interest dialog system 210 may normalize the categories by selecting a single category to represent the related categories. As also discussed above, place of interest dialog system 210 may generate or modify a category score associated with the normalized category based on the related categories.

Process 900 may further include selecting a category for the n-gram based on the category scores (block 910). For example, as described above with respect to n-gram categorization engine 410, place of interest dialog system 210 may select a representative category for the n-gram based on, for example, categories associated with the n-gram and category scores associated with the categories. As also described above, some or all of these category scores may be associated with normalized categories—that is, categories that may be representative of multiple categories.

Process 900 may additionally include storing information associating the selected category with the n-gram (block 915). For example, as described above with respect to n-gram category repository 415, place of interest dialog system 210 may store the information associating the n-gram with the category selected at block 910 using, for example, data structure 700.

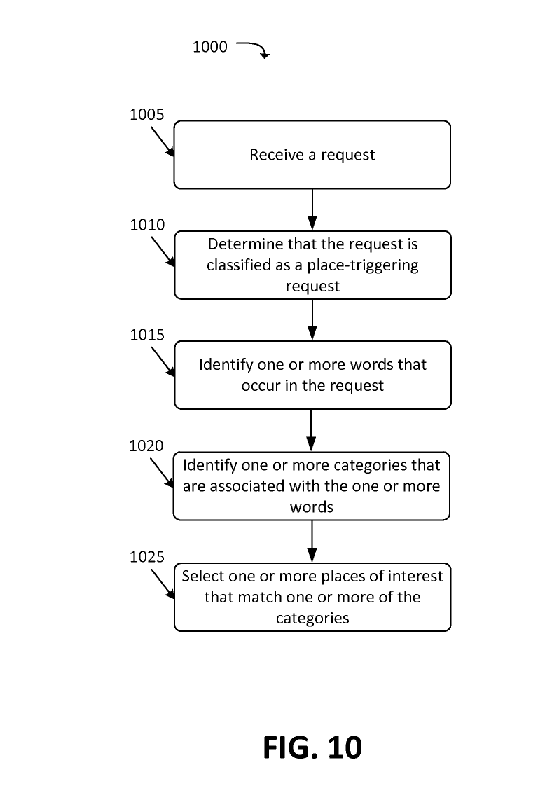

FIG. 10 illustrates a flowchart of an example process 1000 for responding to place-triggering requests. In some implementations, process 1000 may be performed by one or more components of place of interest dialog system 210. In some implementations, some or all of process 1000 may be performed by one or more other components instead of, or possibly in conjunction with, place of interest dialog system 210. For example, in some implementations, some or all of process 1000 may be performed by user device 205.

Process 1000 may include receiving a request (block 1005). For example, as described above with respect to place-triggering question identification engine 505, place of interest dialog system 210 may receive a request from, for example, a user device, such as user device 205. Referring back to the example shown in FIG. 1A, the request may include the phrase “Where can I get some rice and beans?”

Process 1000 may also include determining that the request is classified as a place-triggering request (block 1010). For example, as described above with respect to place-triggering question identification engine 505, place of interest dialog system 210 may determine that the request received at block 1005 is classified as a place-triggering request. In order to determine that the request is classified as a place-triggering request, place of interest dialog system 210 may utilize one or more of a variety of techniques, such as by comparing terms in the request to one or more terms in a list of terms associated with place-triggering requests, performing a semantic analysis of the request, and/or any other technique. Continuing with the above example, place of interest dialog system 210 may determine that the request is classified as a place-triggering request based on the fact that the request includes the word “where.”

Process 1000 may further include identifying one or more words that occur in the request (block 1015). The one or more words may be n-grams. The one or more words may be two or more words that occur successively in the request. For example, as described above with respect to question n-gram extraction engine 510, place of interest dialog system 210 may extract n-grams from the request received at block 1005. Continuing with the above example, place of interest dialog system 210 may extract the n-grams “can I get,” “I get rice,” “rice and beans,” “rice beans,” and/or other n-grams from the request received at block 1005.

Process 1000 may additionally include identifying one or more categories that are associated with the one or more words (block 1020). For example, as described above with respect to question category identification module 515, place of interest dialog system 210 may identify one or more categories associated with one or more of the n-grams extracted at block 1015.

Place of interest dialog system 210 may identify the one or more categories by determining one or more categories of the categories of places of interest where the one or more words that occur in the request are at least one of, an exact match to or beyond a similarity threshold with, one or more words the data structure associates with the one or more categories. For example, in order to identify a category associated with one or more of the extracted n-grams, place of interest dialog system 210 may compare the extracted n-grams to information that associates n-grams with categories. As described above, place of interest dialog system 210 may identify this information in a repository, such as n-gram category repository 415. Continuing with the above example, place of interest dialog system 210 may identify that the n-gram “rice beans” is associated with a “Mexican restaurant” category.

Process 1000 may also include selecting one or more places of interest that match one or more of the categories (block 1025). For example, as described above with respect to question category identification module 515, place of interest dialog system 210 may output information regarding the category identified at block 1025 to one or more devices, such as user device 205, search engine server 215, and/or one or more logs. As discussed above, the information outputted at block 1025 may include a request for search engine server 215 to perform a search based on the identified category, some or all of the question, and/or other information.

The search engine server 215 may identify to the place of interest dialog system 210 one or more places of interest that match the one or more categories. The place of interest dialog system 210 may then select one or more of the identified one or more places of interest that match the one or more categories. Continuing with the above example, and as shown in FIG. 1C, place of interest dialog system 210 may further transmit data to user device 205 identifying one or more places of interest of the one or more selected places of interest, which may allow user device 205 to output an answer, such as “The nearest Mexican restaurant, Uncle Julio's Rio Grande Café, is 1 kilometer away from you.”

Some implementations, described herein, may allow one or more devices to provide responses to requests provided by users. The one or more devices may determine that some requests are classified as place-triggering requests—that is, requests to which a response for which the one or more devices selects one or more places of interest and provides a response identifying the one or more selected places of interest. The responses provided by the one or more devices in response to place-triggering requests may include information identifying places of interest that are related to the questions, thus enhancing users' experiences.

The foregoing description provides illustration and description, but is not intended to be exhaustive or to limit the implementations to the precise form disclosed. Modifications and variations are possible in light of the above description or may be acquired from practice of the implementations. For example, while series of blocks have been described with regard to FIGS. 8-10, the order of the blocks may be modified in other implementations. Further, non-dependent blocks may be performed in parallel. Further, in some implementations, processes 800, 900, and/or 1000 may include fewer, additional, or different blocks.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A computer-implemented method comprising:
receiving, by a dialog system, a request;
determining that the request is classified as a place-triggering request for which a response is to identify a place of interest;
in response to determining that the request is classified as a place-triggering request, generating multiple n-grams that each include two or more words from the request;
for each of the multiple n-grams that are generated from the request, identifying a single, respective candidate category of place of interest that (i) is associated with the n-gram, and (ii) has an associated category score that reflects that the n-gram has occurred in one or more documents that are associated with the category of place of interest a highest number of times;
for each of the multiple n-grams that are generated from the request, comparing the associated category score of the single candidate category of places of interest to a similarity threshold;
selecting a particular category of places from among the candidate categories of places that are identified for the multiple n-grams that are generated from the request, whose associated category score satisfies the similarity threshold;
selecting one or more places of interest that match the particular category of places; and
providing, by the dialog system, a response that identifies the selected one or more places of interest.

21-39. (canceled)

40. The computer-implemented method of claim 1, wherein the place-triggering request is a request including one or more words associated with a question about a location of a place.

41. The computer-implemented method of claim 40, wherein
determining that the request is classified as a place-triggering request comprises determining the request includes one or more words associated with a question about a location of a place.

42. The computer-implemented method of claim 1, wherein the place-triggering request is a request for which the dialog system selects one or more candidate categories of places that are associated with the n-grams.

43. The computer-implemented method of claim 1, comprising:
transmitting data identifying the particular category of places, from among the candidate categories of places that are identified for the multiple n-grams that are generated from the request, whose associated category score satisfies the similarity threshold, to the user device.

44. The computer-implemented method of claim 1, wherein the n-grams comprise two or more words that occur consecutively in the request.

45. The computer-implemented method of claim 1, wherein the category score associating a category of places, from among the candidate categories of places, with the n-grams corresponds to a level of association of the particular category of places with the n-grams.

46. (canceled)

47. A system comprising:
one or more computers and one or more storage devices storing instructions that are operable, when executed by the one or more computers, to cause the one or more computers to perform operations comprising:
receiving, by a dialog system, a request;
determining that the request is classified as a place-triggering request for which a response is to identify a place of interest;
in response to determining that the request is classified as a place-triggering request, generating multiple n-grams that each include two or more words from the request;
for each of the multiple n-grams that are generated from the request, identifying a single, respective candidate category of place of interest that (i) is associated with the n-gram, and (ii) has an associated category score that reflects that the n-gram has occurred in one or more documents that are associated with the category of place of interest a highest number of times;
for each of the multiple n-grams that are generated from the request, comparing the associated category score of the single candidate category of places of interest to a similarity threshold;
selecting a particular category of places from among the candidate categories of places that are identified for the multiple n-grams that are generated from the request, whose associated category score satisfies the similarity threshold;
selecting one or more places of interest that match the particular category of places; and
providing, by the dialog system, a response that identifies the selected one or more places of interest.

48. The system of claim 47, wherein the place-triggering request is a request including a one or more words associated with a question about a location of a place.

49. The system of claim 48, wherein the place-triggering request is a request for which one or more candidate categories of places are selected that are associated with the one or more words.

50. The system of claim 47, wherein the operations comprise:
transmitting data identifying the particular category of places, from among the candidate categories of places that are identified for the multiple n-grams that are generated from the request, whose associated category score satisfies the similarity threshold, to the user device.

51. The system of claim 47, wherein the category score associating a category of places, from among the candidate categories of places, with the n-grams corresponds to a level of association of the particular category of places with the n-grams.

52. (canceled)

53. A non-transitory computer-readable medium storing software comprising instructions executable by one or more computers which, upon such execution, cause the one or more computers to perform operations comprising:
receiving, by a dialog system, a request;
determining that the request is classified as a place-triggering request for which a response is to identify a place of interest;
in response to determining that the request is classified as a place-triggering request, generating multiple n-grams that each include two or more words from the request;
for each of the multiple n-grams that are generated from the request, identifying a single, respective candidate category of place of interest that (i) is associated with the n-gram, and (ii) has an associated category score that reflects that the n-gram has occurred in one or more documents that are associated with the category of place of interest a highest number of times;
for each of the multiple n-grams that are generated from the request, comparing the associated category score of the single candidate category of places of interest to a similarity threshold;
selecting a particular category of places from among the candidate categories of places that are identified for the multiple n-grams that are generated from the request, whose associated category score satisfies the similarity threshold;
selecting one or more places of interest that match the particular category of places; and
providing, by the dialog system, a response that identifies the selected one or more places of interest.

54. The medium of claim 53, wherein the place-triggering request is a request including one or more words associated with a question about a location of a place.

55. The medium of claim 54, wherein the place-triggering request is a request for which the dialog system selects one or more candidate categories of places that are associated with the one or more words.

56. The medium of claim 53, comprising:
transmitting data identifying the particular category of places, from among the candidate categories of places that are identified for the multiple n-grams that are generated from the request, whose associated category score satisfies the similarity threshold, to the user device.

57. The medium of claim 53, wherein the category score associating a category of places, from among the candidate categories of places, with the n-grams corresponds to a level of association of the particular category of places with the n-grams.

58. (canceled)
